(19) United States
(12) Patent Application Publication
(10) Pub. No.: US 2026/0121444 A1
(43) Pub. Date: Apr. 30, 2026

(54) METHOD, APPARATUS, DEVICE AND STORAGE MEDIUM FOR GENERATING ELECTRIC POWER DISPATCHING TASK

(71) Applicants: GUANGDONG POWER GRID CO., LTD., Guangdong (CN); Dongguan Power Supply Bureau of Guangdong Power Grid Co., Ltd., Dongguan City (CN)

(72) Inventors: Weijian LAI, Guangdong (CN); Yujian YANG, Guangdong (CN); Shuan LIU, Guangdong (CN); Tuyou SI, Guangdong (CN); Zejian QIU, Guangdong (CN); Xinlei CAI, Guangdong (CN); Runfeng HU, Guangdong (CN); Jingguang LI, Guangdong (CN); Jiahui CHEN, Guangdong (CN); Songlin LUO, Guangdong (CN)

(73) Assignees: GUANGDONG POWER GRID CO., LTD., Guangdong (CN); Dongguan Power Supply Bureau of Guangdong Power Grid Co., Ltd., Dongguan City (CN)

(21) Appl. No.: 19/306,253

(22) Filed: Aug. 21, 2025

(30) Foreign Application Priority Data
Oct. 29, 2024 (CN) 202411522657.4

(51) Int. Cl. H02J 13/00; G05B 13/02

(52) U.S. Cl. CPC H02J 13/00; G05B 13/0265

(57) ABSTRACT

A method, apparatus, device and storage medium for generating electric power dispatching task are provided, where the method includes: obtaining current operating data of a target power grid, where the operating data includes an operating parameter of each electric power device in the target power grid; extracting a global operating feature representing global operating information of the target power grid from the operating data; extracting, for each electric power device from the operating data, a local feature of a neighborhood with the electric power device as a topological center; fusing the global operating feature and the local feature of each electric power device to obtain a fused feature; and generating an electric power dispatching task based on the fused feature, where the electric power dispatching task includes a dispatching operation of each electric power device.

### CROSS-REFERENCE TO RELATED APPLICATION

This application claims priority to Chinese Patent Application No. 202411522657.4, filed on Oct. 29, 2024, which is hereby incorporated by reference in its entirety.

### TECHNICAL FIELD

The present disclosure relates to electric power dispatching technology, and in particular to a method, apparatus, device and storage medium for generating electric power dispatching task.

### BACKGROUND

The specific work content of electric power dispatching is, based on the data information fed back by various information collection devices and the information provided by monitoring personnel, combined with the actual operating parameters of the power grid, such as voltage, current, frequency, load, etc., and comprehensively considering the development of various production work, to judge the safety and economic operation status of the power grid, issue operating instructions, and control the system to make adjustments, such as adjusting the output of generators, adjusting load distribution, switching capacitors and reactors, etc., so as to ensure the continuous safe and stable operation of the power grid.

Traditional electric power dispatching can be defined as modeling various basic units in the target power grid from the system level, determining the optimization variables, constraints and objectives in the dispatching optimization model, and then finding the optimal solution that meets the constraints under the guidance of the objectives. Based on this kind of theoretical framework, the dispatching optimization method is guided.

However, with the rapid development of the electric power system, the physical characteristics of the power generating side and the power consuming side have gradually diversified. The large-scale application of new energy such as wind energy and solar energy and the massive number of dispatchable units have significantly increased the modeling cost, the dispatching optimization problem has become increasingly complex, and the efficiency of traditional model-based dispatching optimization methods has significantly decreased.

### SUMMARY

The present disclosure provides a method, apparatus, device and storage medium for generating electric power dispatching task, so as to improve the generating efficiency and accuracy of the generation for the electric power dispatching task and reduce cost.

In a first aspect, the present disclosure provides a method for generating electric power dispatching task, including:
obtaining current operating data of a target power grid, where the operating data includes an operating parameter of each electric power device in the target power grid, and the operating parameter includes a current, a voltage, a power, and an operating status;
extracting a global operating feature representing global operating information of the target power grid from the operating data;
extracting, for each electric power device from the operating data, a local feature of a neighborhood with the electric power device as a topological center;
fusing the global operating feature and the local feature of each electric power device to obtain a fused feature; and
generating an electric power dispatching task based on the fused feature, where the electric power dispatching task includes a dispatching operation of each electric power device.

Optionally, extracting the global operating feature representing global operating information of the target power grid from the operating data includes:
performing embedding processing on the operating data to obtain a first embedding feature represented by a vector of the operating data;
performing linearization, batch normalization, and nonlinear activation on the first embedding feature to obtain a first regularization feature;
performing encoding processing on the first regularization feature based on a self-attention mechanism to obtain an encoded feature; and
performing global pooling processing on the encoded feature to obtain the global operating feature representing global operating information of the target power grid.

Optionally, performing encoding processing on the first regularization feature based on the self-attention mechanism to obtain the encoded feature includes:
inputting the first regularization feature into a self-attention module for processing, where the self-attention module includes multiple cascaded self-attention units, an input feature of a first self-attention unit is the first regularization feature, an input feature of an i^{th} self-attention unit is an output feature of an (i−1)^{th} self-attention unit, various self-attention units are used for outputting multiple attention features with different feature scales, and i is a positive integer greater than 1;
concatenating the multiple attention features with different feature scales in a spatial dimension to obtain a concatenated feature; and
performing linearization, batch normalization, and nonlinear activation on the concatenated feature to obtain the encoded feature.

Optionally, extracting, for each electric power device from the operating data, the local feature of the neighborhood with the electric power device as the topological center includes:
determining, for each electric power device, a neighborhood device with the electric power device as the topological center;
filtering, from the operating data, operating data corresponding to the neighborhood device as neighborhood operating data;
performing embedding processing on the neighborhood operating data to obtain a second embedding feature represented by a vector of the neighborhood operating data;
performing linearization, batch normalization, and nonlinear activation on the second embedding feature to obtain a second regularization feature; and
performing convolution processing on the second regularization feature to obtain the local feature of the neighborhood with the electric power device as the topological center.

Optionally, generating the electric power dispatching task based on the fused feature includes:
performing linearization processing on the fused feature to obtain a linearized feature; and
mapping the linearized feature to an instruction library of the electric power dispatching task to generate the electric power dispatching task.

Optionally, after generating the electric power dispatching task based on the fused feature, the method further includes:
performing verification on a dispatching operation of each device in the generated electric power dispatching task based on a pre-built rule engine.

Optionally, after generating the electric power dispatching task based on the fused feature, the method further includes:
collecting feedback data fed back by each electric power device after executing the electric power dispatching task; and
optimizing a model parameter of a model for generating electric power dispatching task by using the feedback data as training data.

In a second aspect, the present disclosure further provides an apparatus for generating electric power dispatching task, including:
an operating data obtaining module, configured to obtain current operating data of a target power grid, where the operating data includes an operating parameter of each electric power device in the target power grid, and the operating parameter includes a current, a voltage, a power, and an operating status;
a global feature extracting module, configured to extract a global operating feature representing global operating information of the target power grid from the operating data;
a local feature extracting module, configured to extract, for each electric power device from the operating data, a local feature of a neighborhood with the electric power device as a topological center;
a feature fusing module, configured to fuse the global operating feature and the local feature of each electric power device to obtain a fused feature; and
a dispatching task generating module, configured to generate an electric power dispatching task based on the fused feature, where the electric power dispatching task includes a dispatching operation of each electric power device.

In a third aspect, the present disclosure further provides an electronic device, including:
one or more processors; and
a storage apparatus, configured to store one or more programs;
where the method for generating electric power dispatching task provided in the first aspect of the present disclosure is implemented by the one or more processors when the one or more programs are executed by the one or more processors.

In a fourth aspect, the present disclosure further provides a computer-readable storage medium having a computer program stored thereon, where, when executed by a processor, implements the method for generating electric power dispatching task provided in the first aspect of the present disclosure.

The method for generating electric power dispatching task is provided by the present disclosure, including: obtaining current operating data of a target power grid, where the operating data includes an operating parameter of each electric power device in the target power grid, and the operating parameter includes a current, a voltage, a power, and an operating status; extracting a global operating feature representing global operating information of the target power grid from the operating data; extracting, for each electric power device from the operating data, a local feature of a neighborhood with the electric power device as a topological center; fusing the global operating feature and the local feature of each electric power device to obtain a fused feature; and generating an electric power dispatching task based on the fused feature, where the electric power dispatching task includes a dispatching operation of each electric power device. The present disclosure adopts a large model based on deep learning, and automatically generates the electric power dispatching task by using the current operating data of the target power grid. Comparing with the existing modeling method, the generating efficiency of the generation for the electric power dispatching task is improved and the cost is reduced. In addition, the present disclosure fuses the global operating feature of the global operating information of the target power grid and the local feature of the neighborhood with the electric power device as the topological center to generate the electric power dispatching task, thereby improving the accuracy of the electric power dispatching task.

It should be understood that the contents described in this section are not intended to identify the key or important features of the embodiments of the present disclosure, nor are they intended to limit the scope of the present disclosure. Other features of the present disclosure will become easily understood through the following description.

### BRIEF DESCRIPTION OF DRAWINGS

In order to more clearly illustrate the technical solutions in the embodiments of the present disclosure, the following briefly introduces the drawings required for use in the description of the embodiments. Obviously, the drawings described below are only some embodiments of the present disclosure. For those skilled in the art, other drawings can be obtained based on these drawings without creative work.

FIG. 1 is a flow chart of a method for generating electric power dispatching task provided by the present disclosure.

FIG. 2 is a structural schematic diagram of a model for generating electric power dispatching task provided by the present disclosure.

FIG. 3 is a structural schematic diagram of an apparatus for generating electric power dispatching task provided by the present disclosure.

FIG. 4 is a structural schematic diagram of an electronic device provided by the present disclosure.

The above drawings have shown clear embodiments of the present disclosure, which will be described in more detail later. These drawings and text descriptions are not intended to limit the scope of the present disclosure in any way, but to illustrate the concept of the present disclosure to those skilled in the art by referring to specific embodiments.

### DESCRIPTION OF EMBODIMENTS

In order to enable those skilled in the art to better understand the solutions of the present disclosure, the technical solutions in the embodiments of the present disclosure will be clearly and completely described below in conjunction with the drawings in the embodiments of the present disclosure. Obviously, the described embodiments are only part of the embodiments of the present disclosure, not all of the embodiments. Based on the embodiments of the present disclosure, all other embodiments obtained by those skilled in the art without creative work should fall within the protection scope of the present disclosure.

It should be noted that the terms “first”, “second”, etc. in the specification and claims of the present disclosure and the above-mentioned drawings are used to distinguish similar objects, and are not necessarily used to describe a specific order or sequence. It should be understood that the data used in this way can be interchanged where appropriate, so that the embodiments of the present disclosure described herein can be implemented in an order other than those illustrated or described herein. In addition, the terms “including” and “having” and any variations thereof are intended to cover non-exclusive inclusions, for example, a process, method, system, product or device that includes a series of steps or units is not necessarily limited to those steps or units that are clearly listed, but may include other steps or units that are not clearly listed or inherent to these processes, methods, products or devices.

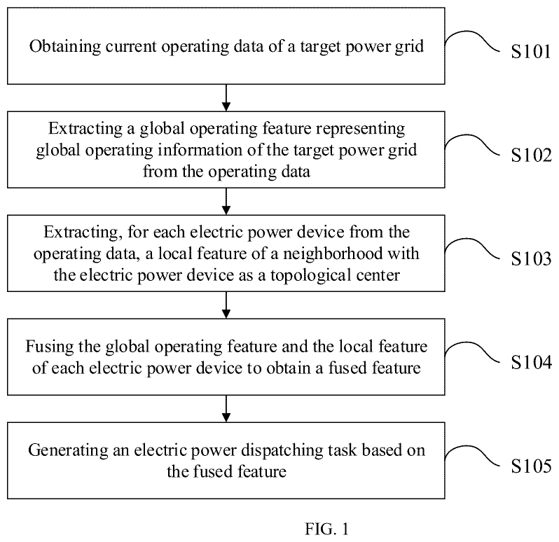

FIG. 1 is a flow chart of a method for generating electric power dispatching task provided by the present disclosure. The present embodiment is applicable to the case where an electric power dispatching task is automatically generated based on the current operating data of the target power grid. The method can be executed by an apparatus for generating electric power dispatching task provided by an embodiment of the present disclosure. The apparatus can be implemented by software and/or hardware, and is usually configured in an electronic device. As shown in FIG. 1, the method for generating electric power dispatching task specifically includes the following steps.

S101, obtaining current operating data of a target power grid.

In an embodiment of the present disclosure, the method for generating electric power dispatching task can be executed by an electric power dispatching platform, and the electric power dispatching platform obtains the current operating data of the target power grid in real time. The target power grid can be a power network managed by a certain transformer substation or multiple transformer substations, and the operating data can include an operating parameter of each electric power device in the target power grid, and the operating parameter includes a current, a voltage, a power, and an operating status (such as normal, overload, shutdown, etc.). The electric power device can include a substation, a power station, a load point, etc., which are not limited in the embodiments of the present disclosure.

Exemplarily, a corresponding sensor or a corresponding data collecting device can be set at the electric power device to collect the operating parameter of each electric power device, which then can be uploaded to the electric power dispatching platform in real time through an Internet of Things device. In a specific embodiment of the present disclosure, a stable real-time interactive link is established between the electric power dispatching platform and the Internet of Things device through a standard communication protocol (such as HTTP or gRPC). The operating data of the target power grid is transmitted to the electric power dispatching platform through a standardized interface (for example, an interface based on a format such as JSON, XML, etc.), so as to ensure that the data can be transmitted in real time and quickly parsed for the next task generation. In this stage, the efficient transmission of data is guaranteed and the delay is reduced, so as to ensure that the process for generating electric power dispatching task can reflect the dynamic changes of the target power grid in real time.

S102, extracting a global operating feature representing global operating information of the target power grid from the operating data.

In an embodiment of the present disclosure, the operating data is vectorized (matrixed) and then input into a model for generating electric power dispatching task provided in the embodiments of the present disclosure for processing, where the model for generating electric power dispatching task performs inference to finally generate the electric power dispatching task. The model for generating electric power dispatching task uses a large amount of historical dispatching data and power grid operating data for learning and training, and learns a complex relationship between an operating status of electric power device and a dispatching command. Exemplarily, the vectorized operating data is input into a feature extracting network of the model for generating electric power dispatching task for feature extraction, and the global operating feature representing the global operating information of the target power grid is extracted from the operating data. The global operating feature represents overall attributes of entire operating data.

It should be noted that the above-mentioned global operating feature can be extracted using a deep convolutional network or a Transformer architecture, which is not limited in the embodiments of the present disclosure.

In some embodiments of the present disclosure, extracting the global operating feature representing global operating information of the target power grid from the operating data includes:

S1021, performing embedding processing on the operating data to obtain a first embedding feature represented by a vector of the operating data.

Exemplarily, the embedding processing is performed on the operating data to obtain the first embedding feature represented by the vector of the operating data. Exemplarily, a vector representation of the first embedding feature is as follows:

$$X = \{ {x}_{1 ,} {x}_{2 ,} … {x}_{n} \}$$

where, X is the first embedding feature, xᵢ is a vector composed of an operating parameter of the i^{th} electric power device, where 1≤i≤n, and i is a positive integer.

S1022, performing linearization, batch normalization, and nonlinear activation on the first embedding feature to obtain a first regularization feature.

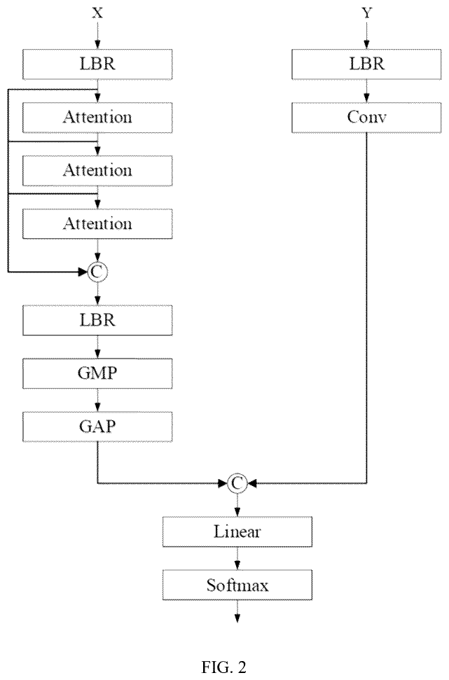

FIG. 2 is a structural schematic diagram of a model for generating electric power dispatching task provided by the present disclosure. As shown in FIG. 2, the first embedding feature X is input into a linear batch normalization ReLU (LBR) unit for processing. The LBR unit includes a linearization layer (Linear), a batch normalization layer (Batch Normalization) and a Rule function activation layer connected in sequence. The linearization layer performs linearization on the first embedding feature X, the batch normalization layer performs batch normalization processing on a feature output by the linearization layer, and the Rule function activation layer performs nonlinear activation on a feature output by the batch normalization layer, and finally the first regularization feature is obtained.

S1023, performing encoding processing on the first regularization feature based on a self-attention mechanism to obtain an encoded feature.

In an embodiment of the present disclosure, the encoding processing is performed on the first regularization feature based on the self-attention mechanism to capture a correlation between various elements in the first regularization feature, which is beneficial to improving the accuracy of the generated electric power dispatching task.

Exemplarily, as shown in FIG. 2, the first regularization feature is input into a self-attention module for processing, where the self-attention module includes multiple cascaded self-attention units (Attention), an input feature of a first self-attention unit is the first regularization feature, an input feature of an i^{th} self-attention unit is an output feature of an (i−1)^{th} self-attention unit, various self-attention units are used for outputting multiple attention features with different feature scales, and i is a positive integer greater than 1. Each self-attention unit can process the input features in a common self-attention processing method, that is, performing linear transformation the input features respectively to obtain a query matrix, a key matrix, and a value matrix, calculating the dot product of the query matrix and the key matrix, which then are normalized to obtain an attention weight matrix, calculating the dot product of the attention weight matrix and the value matrix to obtain a self-attention matrix, and finally calculating a sum of the self-attention matrix and the input feature to obtain the output feature of the self-attention unit. The embodiments of the present disclosure will not be described in detail here.

As shown in FIG. 2, the multiple attention features with different feature scales (i.e., the output feature of each self-attention unit) are concatenated in a spatial dimension (represented by C in the figure) to obtain a concatenated feature.

As shown in FIG. 2, linearization, batch normalization, and nonlinear activation are performed on the concatenated feature to obtain the encoded feature. Specifically, the concatenated feature is input into an LBR unit for linearization, batch normalization, and nonlinear activation to obtain the encoded feature. The structure of the LBR unit is the same as that of the LBR unit in the aforementioned embodiment. The embodiments of the present disclosure will not be described in detail here.

S1024, performing global pooling processing on the encoded feature to obtain the global operating feature representing global operating information of the target power grid.

As shown in FIG. 2, global pooling processing is performed on the encoded feature to obtain the global operating feature representing global operating information of the target power grid. Exemplarily, in an embodiment of the present disclosure, the encoded feature is first input into a global max-pooling layer (GMP), and an output result of the global max-pooling layer is input into a global average-pooling layer (GAP), and finally the global operating feature representing the global operating information of the target power grid is obtained.

S103, extracting, for each electric power device from the operating data, a local feature of a neighborhood with the electric power device as a topological center.

In an embodiment of the present disclosure, for each electric power device, the local feature of the neighborhood with the electric power device as the topological center is extracted from the operating data. Exemplarily, with each electric power device as the topological center, the electric power device is determined as the neighborhood device of the topological center and the operating data corresponding to the neighborhood device is determined, and a feature extracting network is used for extracting the local feature representing an association relationship between various devices in the neighborhood device from the operating data corresponding to the neighborhood device.

In some embodiments of the present disclosure, extracting, for each electric power device from the operating data, the local feature of the neighborhood with the electric power device as the topological center includes the following steps.

S1031, determining, for each electric power device, a neighborhood device with the electric power device as the topological center.

In the embodiments of the present disclosure, based on a topological structure of the target power grid, for each electric power device, determining the neighborhood device with the electric power device as the topological center, where the neighborhood device includes an electric power device at the topological center and other electric power devices connected to the topological center.

S1032, filtering, from the operating data, operating data corresponding to the neighborhood device as neighborhood operating data.

After determining the neighborhood device with the electric power device as the topological center, the operating data corresponding to the neighborhood device is filtered from the operating data obtained in the above steps as the neighborhood operating data of the electronic device. Exemplarily, the operation parameter of each electronic device in the operating data has a unique identifier of the electronic device, and the operating data corresponding to the neighborhood device can be filtered from the operating data as the neighborhood operating data based on the identifier.

S1033, performing embedding processing on the neighborhood operating data to obtain a second embedding feature represented by a vector of the neighborhood operating data.

In an embodiment of the present disclosure, embedding processing is performed on the neighborhood operating data to obtain the second embedding feature represented by the vector of the neighborhood operating data. Exemplarily, the vector representation of the second embedding feature is as follows:

$${Y}_{j} = \{ {y}_{1} , {y}_{2} , … {y}_{n} \}$$

where, Yⱼ is the second embedding feature corresponding to the j^{th} electric power device, and yᵢ is a vector composed of the operating parameter of the i^{th} neighborhood device of the j^{th} electric power device, where 1≤i≤n, and i is a positive integer.

S1034, performing linearization, batch normalization, and nonlinear activation on the second embedding feature to obtain a second regularization feature.

In an embodiment of the present disclosure, the second embedding features corresponding to all electric power devices can be combined into a matrix Y, and then linearization, batch normalization, and nonlinear activation are performed the matrix to obtain the second regularization feature. Exemplarily, as shown in FIG. 2, the matrix Y is input into a LBR unit for processing. The LBR unit includes a linearization layer (Linear), a batch normalization layer (Batch Normalization) and a Rule function activation layer connected in sequence. The linearization layer performs linearization on the matrix Y, the batch normalization layer performs batch normalization processing on a feature output by the linearization layer, and the Rule function activation layer performs nonlinear activation on a feature output by the batch normalization layer, and finally the second regularization feature is obtained.

S1035, performing convolution processing on the second regularization feature to obtain the local feature of the neighborhood with the electric power device as the topological center.

In an embodiment of the present disclosure, as shown in FIG. 2, the second regularization feature is input into a convolution unit (Conv) for performing convolution processing to obtain the local feature of the neighborhood with each electric power device as the topological center. In the embodiment of the present disclosure, a structure of the convolution unit is not limited and can include one or more convolution layers.

S104, fusing the global operating feature and the local feature of each electric power device to obtain a fused feature.

As shown in FIG. 2, in an embodiment of the present disclosure, the global operating feature and the local feature of each electric power device are concatenated in the feature dimension (indicated by C in the figure) to obtain the fused feature.

S105, generating an electric power dispatching task based on the fused feature.

In an embodiment of the present disclosure, the electric power dispatching task is generated based on the fused feature. The electric power dispatching task includes a dispatching operation of each electric power device. The dispatching operation includes starting or shutting down the device, adjusting the load distribution, switching the backup power supply, etc. The embodiments of the present disclosure are not limited here. The generated electric power dispatching task can be expressed as a sequence:

$$T = \{ {t}_{1} , {t}_{2} , … , {t}_{k} \}$$

where, T is an entire electric power dispatching task, and tᵢ is a specific instruction of the i^{th} dispatching operation.

Exemplarily, as shown in FIG. 2, the fused feature is input into a linear layer (Linear), linearization processing is performed on the fused feature to obtain the linearized feature, and then the linearized feature is input into an activation function layer (Softmax), the linearized feature is mapped to an instruction library of the electric power dispatching task, so as to generate the electric power dispatching task.

The method for generating electric power dispatching task is provided by the present disclosure, including: obtaining current operating data of a target power grid, where the operating data includes an operating parameter of each electric power device in the target power grid, and the operating parameter includes a current, a voltage, a power, and an operating status; extracting a global operating feature representing global operating information of the target power grid from the operating data; extracting, for each electric power device from the operating data, a local feature of a neighborhood with the electric power device as a topological center; fusing the global operating feature and the local feature of each electric power device to obtain a fused feature; and generating an electric power dispatching task based on the fused feature, where the electric power dispatching task includes a dispatching operation of each electric power device. The present disclosure adopts a large model based on deep learning, and automatically generates the electric power dispatching task by using the current operating data of the target power grid. Comparing with the existing modeling method, the generating efficiency of the generation for the electric power dispatching task is improved and the cost is reduced. In addition, the present disclosure fuses the global operating feature of the global operating information of the target power grid and the local feature of the neighborhood with the electric power device as the topological center to generate the electric power dispatching task, thereby improving the accuracy of the electric power dispatching task.

In some embodiments of the present disclosure, in order to improve the safety of the electric power dispatching task and avoid unsafe dispatching operations in the generated electric power dispatching task, which may cause safety problems after execution, after generating the electric power dispatching task based on the fused feature, the following step is further included.

Performing verification on a dispatching operation of each device in the generated electric power dispatching task based on a pre-built rule engine.

Exemplarily, the rule engine is a predefined set of business rule system for ensuring that the generated dispatching task meets the dispatching rules such as the safety of the power grid, load capacity of the device, the priority, etc. The rule engine will perform verification on each dispatching operation in the generated electric power dispatching task. The verification content may include: the compliance of the task (whether it complies with the dispatching strategy), whether the device can withstand the task operation (such as whether the load exceeds the limit), the priority of task execution, etc., which are not limited in the present disclosure. Through the verification of the rule engine, it can be ensured that each dispatching operation in the electric power dispatching task is safe and executable after it is generated.

In some embodiments of the present disclosure, the verified electric power dispatching task is sent to a dispatcher, who executes the electric power dispatching task, or the verified electric power dispatching task is directly sent to the corresponding execution device to automatically execute the electric power dispatching task. After the electric power dispatching task is executed, the feedback data fed back by each electric power device is collected. The feedback data may include the execution status of the task (success/failure), the specific time of execution (start time, end time), and the response status of the device (whether it meets expectations). These feedback data are transmitted to the electric power dispatching platform through the interface as the basis for optimizing the model. The feedback data are used as training data to optimize the model parameter of the model for generating electric power dispatching task.

Exemplarity, in R={r₁, r₂, . . . , rₖ}, rᵢ represents the feedback data of the i^{th} electric power device. The feedback data is used as training data to optimize the model parameter of the model for generating electric power dispatching task, which can further provide the accuracy of the generated electric power dispatching task. The specific optimization process is based on the following loss function:

$$L ( θ ) = \frac{1}{k} {\sum }_{i = 1}^{k} {( {f}_{θ} ( {x}_{i} ) - {r}_{i} )}^{2}$$

where, f_{θ}(xᵢ) is a specific instruction of the i^{th} dispatching operation in the generated electric power dispatching task (i.e., tᵢ in the previous contents). By minimizing the loss function, the model parameter of the model for generating electric power dispatching task can be adjusted to enable the generated task to be more in line with the actual situation.

Self-learning is performed by receiving feedback data from task execution in real time. After each task is completed, the model uses the feedback data as new training data and updates the model parameter. Self-learning algorithm is based on an incremental learning strategy, so that the model can process new data without retraining. As the feedback data continues to increase, the model can better adapt to changes in the power grid state. The model dynamically optimizes the generated dispatching task by adjusting the task generating strategy. The dynamic optimization process of the model updates the parameter through the gradient descent algorithm to minimize the loss function and achieve continuous improvement in the dispatching task generation.

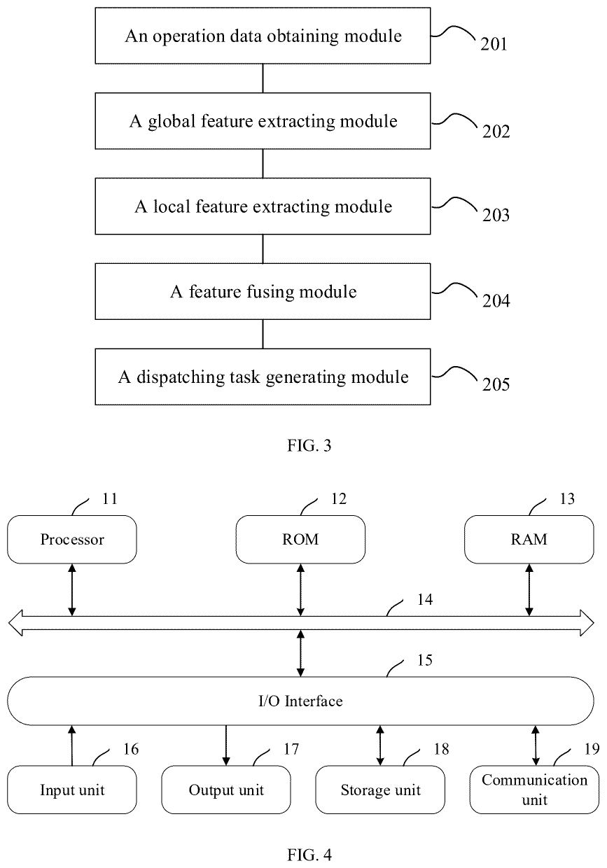

FIG. 3 is a structural schematic diagram of an apparatus for generating electric power dispatching task provided by the present disclosure. As shown in FIG. 3, the apparatus for generating electric power dispatching task includes:
an operating data obtaining module 201, configured to obtain current operating data of a target power grid, where the operating data includes an operating parameter of each electric power device in the target power grid, and the operating parameter includes a current, a voltage, a power, and an operating status;
a global feature extracting module 202, configured to extract a global operating feature representing global operating information of the target power grid from the operating data;
a local feature extracting module 203, configured to extract, for each electric power device from the operating data, a local feature of a neighborhood with the electric power device as a topological center;
a feature fusing module 204, configured to fuse the global operating feature and the local feature of each electric power device to obtain a fused feature; and
a dispatching task generating module 205, configured to generate an electric power dispatching task based on the fused feature, where the electric power dispatching task includes a dispatching operation of each electric power device.

In some embodiments of the present disclosure, the global feature extracting module 202 includes:
a first embedding submodule, configured to perform embedding processing on the operating data to obtain a first embedding feature represented by a vector of the operating data;
a first regularizing submodule, configured to perform linearization, batch normalization, and nonlinear activation on the first embedding feature to obtain a first regularization feature;
a self-attention encoding submodule, configured to perform encoding processing on the first regularization feature based on a self-attention mechanism to obtain an encoded feature; and
a global pooling processing module, configured to perform global pooling processing on the encoded feature to obtain the global operating feature representing global operating information of the target power grid.

In some embodiments of the disclosure, the self-attention encoding submodule includes:
a self-attention processing unit, configured to input the first regularization feature into a self-attention module for processing, where the self-attention module includes multiple cascaded self-attention units, an input feature of a first self-attention unit is the first regularization feature, an input feature of an i^{th} self-attention unit is an output feature of an (i−1)^{th} self-attention unit, various self-attention units are used for outputting multiple attention features with different feature scales, and i is a positive integer greater than 1;
a feature concatenating unit, configured to concatenate the multiple attention features with different feature scales in a spatial dimension to obtain a concatenated feature; and
an encoded feature calculating unit, configured to perform linearization, batch normalization, and nonlinear activation on the concatenated feature to obtain the encoded feature.

In some embodiments of the present disclosure, the local feature extracting module 203 includes:
a neighborhood device determining submodule, configured to determine, for each electric power device, a neighborhood device with the electric power device as the topological center;
a data filtering submodule, configured to filter, from the operating data, operating data corresponding to the neighborhood device as neighborhood operating data;
a second embedding submodule, configured to perform embedding process on the neighborhood operating data to obtain a second embedding feature represented by a vector of the neighborhood operating data;
a second regularizing submodule, configured to perform linearization, batch normalization, and nonlinear activation on the second embedding feature to obtain a second regularization feature; and
a local feature extracting submodule, configured to perform convolution processing on the second regularization feature to obtain the local feature of the neighborhood with the electric power device as the topological center.

In some embodiments of the present disclosure, the dispatching task generating module 205 includes:
a linearization processing submodule, configured to perform linearization process on the fused feature to obtain a linearized feature; and
a task generating submodule, configured to map the linearized feature to an instruction library of the electric power dispatching task to generate the electric power dispatching task.

In some embodiments of the present disclosure, the apparatus for generating electric power dispatching task further includes:
a verifying module, configured to perform verification on a dispatching operation of each device in the generated electric power dispatching task based on a pre-built rule engine after the electric power dispatching task is generated based on the fused feature.

In some embodiments of the present disclosure, the apparatus for generating electric power dispatching task further includes:
a feedback data collecting module, configured to collect feedback data fed back by each electric power device after the electric power dispatching task is generated based on the fused feature and the electric power dispatching task is executed; and
a model optimizing module, configured to optimize a model parameter of a model for generating electric power dispatching task by using the feedback data as training data.

The above-mentioned apparatus for generating electric power dispatching task can execute the method for generating electric power dispatching task provided by the above-mentioned embodiments of the present disclosure, and have the corresponding functional modules and beneficial effects for executing the method for generating electric power dispatching task.

FIG. 4 is a structural schematic diagram of an electronic device provided by the present disclosure. The electronic device is intended to represent various forms of digital computers, such as a laptop computer, a desktop computer, a workbench, a personal digital assistant, a server, a blade server, a mainframe computer, and other suitable computers. The electronic device may also represent various forms of mobile apparatus, such as a personal digital processing, a cellular phone, a smart phone, a wearable device (such as a helmet, glasses, a watch, etc.) and other similar computing apparatus. The components shown herein, their connections and relationships, and their functions are merely examples and are not intended to limit the implementation of the present disclosure described and/or required herein.

As shown in FIG. 4, the electronic device includes at least one processor 11, and a memory connected to the at least one processor 11 in communication, such as a read only memory (ROM) 12, a random access memory (RAM) 13, etc., where the memory stores a computer program that can be executed by at least one processor, and the processor 11 can perform various appropriate actions and processes according to the computer program stored in the read only memory (ROM) 12 or the computer program loaded from the storage unit 18 to the random access memory (RAM) 13. In the RAM 13, various programs and data required for the operation of the electronic device can also be stored. The processor 11, the ROM 12, and the RAM 13 are connected to each other via a bus 14. An input/output (I/O) interface 15 is also connected to the bus 14.

A number of components in the electronic device are connected to the I/O interface 15, including: an input unit 16, such as a keyboard, a mouse, etc.; an output unit 17, such as various types of displays, speakers, etc.; a storage unit 18, such as a disk, an optical disk, etc.; and a communication unit 19, such as a network card, a modem, a wireless communication transceiver, etc. The communication unit 19 allows the electronic device to exchange information/data with other devices through a computer network such as the Internet and/or various telecommunication networks.

The processor 11 can be a variety of general and/or special processing components with processing and computing capabilities. Some examples of the processor 11 include, but are not limited to, a central processing unit (CPU), a graphics processing unit (GPU), various special artificial intelligence (AI) computing chips, various processors running machine learning model algorithms, a digital signal processor (DSP), and any appropriate processor, controller, microcontroller, etc. The processor 11 executes the various methods and processes described above, such as the method for generating electric power dispatching task.

In some embodiments, the method for generating electric power dispatching task can be implemented as a computer program, which is tangibly contained in a computer-readable storage medium, such as a storage unit 18. In some embodiments, part or all of the computer program can be loaded and/or installed on the electronic device via the ROM 12 and/or the communication unit 19. When the computer program is loaded into the RAM 13 and executed by the processor 11, one or more steps of the method for generating electric power dispatching task described above may be performed. Alternatively, in other embodiments, the processor 11 can be configured to perform the method for generating electric power dispatching task in any other appropriate manner (e.g., by means of firmware).

Various implementations of the systems and techniques described above herein can be implemented in a digital electronic circuit system, an integrated circuit system, a field programmable gate array (FPGA), an application specific integrated circuit (ASIC), an application specific standard product (ASSP), a system on chip (SOC), a load programmable logic device (CPLD), a computer hardware, a firmware, a software, and/or combinations thereof. These various implementations can include: they are implemented in one or more computer programs that can be executed and/or interpreted on a programmable system including at least one programmable processor, which can be a special purpose or general purpose programmable processor that can receive data and instructions from a storage system, at least one input apparatus, and at least one output apparatus, and transmit data and instructions to the storage system, the at least one input apparatus, and the at least one output apparatus.

The computer program used for implementing the method of the present disclosure can be written in any combination of one or more programming languages. These computer programs can be provided to a processor of a general-purpose computer, a special-purpose computer, or other programmable data processing apparatus, so that when the computer program is executed by the processor, the functions/operations specified in the flow chart and/or block diagram are implemented. The computer program can be executed entirely on the machine, partially on the machine, partially on the machine and partially on a remote machine as a stand-alone software package, or entirely on a remote machine or server.

In the context of the present disclosure, a computer-readable storage medium can be a tangible medium that can contain or store a computer program for use by or in combination with an instruction execution system, apparatus or device. A computer-readable storage medium can include, but is not limited to, electronic, magnetic, optical, electromagnetic, infrared, or semiconductor system, apparatus or device, or any suitable combination of the foregoing. Alternatively, a computer-readable storage medium can be a machine-readable signal medium. A more specific example of a machine-readable storage medium can include an electrical connection based on one or more lines, a portable computer disk, a hard disk, a random access memory (RAM), a read only memory (ROM), an erasable programmable read-only memory (EPROM or flash memory), an optical fiber, a portable compact disk read only memory (CD-ROM), an optical storage device, a magnetic storage device, or any suitable combination of the foregoing.

In order to provide interaction with a user, the systems and techniques described herein may be implemented on an electronic device. The electronic device has: a display device (e.g., a cathode ray tube (CRT) or liquid crystal display (LCD) monitor) for displaying information to the user; and a keyboard and a pointing device (e.g., a mouse or trackball) through which the user can provide input to the electronic device. Other types of apparatuses can also be used to provide interaction with the user; for example, the feedback provided to the user may be any form of sensory feedback (e.g., visual feedback, auditory feedback, or tactile feedback); and input from the user can be received in any form (including acoustic input, voice input, or tactile input).

The systems and techniques described herein can be implemented in a computing system that includes backend components (e.g., as a data server), or a computing system that includes middleware components (e.g., an application server), or a computing system that includes frontend components (e.g., a user computer with a graphical user interface or a web browser through which a user can interact with implementations of the systems and techniques described herein), or a computing system that includes any combination of such backend components, middleware components, or frontend components. The components of the system may be interconnected by any form or medium of digital data communication (e.g., a communication network). Examples of communication networks include: a local area network (LAN), a wide area network (WAN), a blockchain network, and the Internet.

A computing system can include a client and a server. The client and the server are generally remote from each other and usually interact through a communication network. The relationship between client and server is generated by computer programs running on the corresponding computers and having a client-server relationship with each other. The server can be a cloud server, also known as a cloud computing server or cloud host, which is a host product in the cloud computing service system to solve the defects of difficult management and weak business scalability in traditional physical hosts and VPS services.

An embodiment of the present disclosure further provides a computer program product, including a computer program, which, when executed by a processor, implements the method for generating electric power dispatching task provided in any embodiment of the present disclosure.

In the process of implementation, the computer program product can be written in one or more programming languages or a combination thereof to perform the computer program code of the present disclosure, including object-oriented programming languages, such as Java, Smalltalk, C++, and conventional procedural programming languages, such as “C” language or similar programming languages. The program code can be executed entirely on the user's computer, partially on the user's computer, as a separate software package, partially on the user's computer and partially on a remote computer, or entirely on a remote computer or server. In the case of a remote computer, the remote computer can be connected to the user's computer through any type of network, including a local area network (LAN) or a wide area network (WAN), or can be connected to an external computer (for example, using an Internet service provider to connect through the Internet).

It should be understood that the various forms of processes shown above can be used to reorder, add or delete steps. For example, the steps described in the present disclosure can be executed in parallel, sequentially or in different orders, as long as the desired results of the technical solution of the present disclosure can be achieved, which is not limited here.

The above specific implementations do not constitute a limitation on the protection scope of the present disclosure. It should be understood by those skilled in the art that various modifications, combinations, sub-combinations and substitutions can be made according to design requirements and other factors. Any modification, equivalent substitution and improvement made within the spirit and principle of the present disclosure should be included in the protection scope of the present disclosure.

What is claimed is:

1. A method for generating electric power dispatching task, comprising:
obtaining current operating data of a target power grid, wherein the operating data comprises an operating parameter of each electric power device in the target power grid, and the operating parameter comprises a current, a voltage, a power, and an operating status;
extracting a global operating feature representing global operating information of the target power grid from the operating data;
extracting, for each electric power device from the operating data, a local feature of a neighborhood with the electric power device as a topological center;
fusing the global operating feature and the local feature of each electric power device to obtain a fused feature; and
generating an electric power dispatching task based on the fused feature, wherein the electric power dispatching task comprises a dispatching operation of each electric power device.

2. The method for generating electric power dispatching task according to claim 1, wherein extracting the global operating feature representing global operating information of the target power grid from the operating data comprises:
performing embedding processing on the operating data to obtain a first embedding feature represented by a vector of the operating data;
performing linearization, batch normalization, and nonlinear activation on the first embedding feature to obtain a first regularization feature;
performing encoding processing on the first regularization feature based on a self-attention mechanism to obtain an encoded feature; and
performing global pooling processing on the encoded feature to obtain the global operating feature representing global operating information of the target power grid.

3. The method for generating electric power dispatching task according to claim 2, wherein performing encoding processing on the first regularization feature based on the self-attention mechanism to obtain the encoded feature comprises:
inputting the first regularization feature into a self-attention module for processing, wherein the self-attention module comprises multiple cascaded self-attention units, an input feature of a first self-attention unit is the first regularization feature, an input feature of an i^{th} self-attention unit is an output feature of an (i−1)^{th} self-attention unit, various self-attention units are used for outputting multiple attention features with different feature scales, and i is a positive integer greater than 1;
concatenating the multiple attention features with different feature scales in a spatial dimension to obtain a concatenated feature; and
performing linearization, batch normalization, and nonlinear activation on the concatenated feature to obtain the encoded feature.

4. The method for generating electric power dispatching task according to claim 1, wherein extracting, for each electric power device from the operating data, the local feature of the neighborhood with the electric power device as the topological center comprises:
determining, for each electric power device, a neighborhood device with the electric power device as the topological center;
filtering, from the operating data, operating data corresponding to the neighborhood device as neighborhood operating data;
performing embedding processing on the neighborhood operating data to obtain a second embedding feature represented by a vector of the neighborhood operating data;
performing linearization, batch normalization, and nonlinear activation on the second embedding feature to obtain a second regularization feature; and
performing convolution processing on the second regularization feature to obtain the local feature of the neighborhood with the electric power device as the topological center.

5. The method for generating electric power dispatching task according to claim 1, wherein generating the electric power dispatching task based on the fused feature comprises:
performing linearization processing on the fused feature to obtain a linearized feature; and
mapping the linearized feature to an instruction library of the electric power dispatching task to generate the electric power dispatching task.

6. The method for generating electric power dispatching task according to claim 1, wherein after generating the electric power dispatching task based on the fused feature, the method further comprises:
performing verification on a dispatching operation of each device in the generated electric power dispatching task based on a pre-built rule engine.

7. The method for generating electric power dispatching task according to claim 1, wherein after generating the electric power dispatching task based on the fused feature, the method further comprises:
collecting feedback data fed back by each electric power device after executing the electric power dispatching task; and
optimizing a model parameter of a model for generating electric power dispatching task by using the feedback data as training data.

8. An apparatus for generating electric power dispatching task, comprising:
one or more processors; and
a storage apparatus, configured to store one or more programs;
wherein, when the one or more programs are executed by the one or more processors, the following steps are implemented:
obtaining current operating data of a target power grid, wherein the operating data comprises an operating parameter of each electric power device in the target power grid, and the operating parameter comprises a current, a voltage, a power, and an operating status;
extracting a global operating feature representing global operating information of the target power grid from the operating data;
extracting, for each electric power device from the operating data, a local feature of a neighborhood with the electric power device as a topological center;
fusing the global operating feature and the local feature of each electric power device to obtain a fused feature; and
generating an electric power dispatching task based on the fused feature, wherein the electric power dispatching task comprises a dispatching operation of each electric power device.

9. The apparatus for generating electric power dispatching task according to claim 8, wherein, when the one or more programs are executed by the one or more processors, the following steps are further implemented:
performing embedding processing on the operating data to obtain a first embedding feature represented by a vector of the operating data;
performing linearization, batch normalization, and nonlinear activation on the first embedding feature to obtain a first regularization feature;
performing encoding processing on the first regularization feature based on a self-attention mechanism to obtain an encoded feature; and
performing global pooling processing on the encoded feature to obtain the global operating feature representing global operating information of the target power grid.

10. The apparatus for generating electric power dispatching task according to claim 9, wherein, when the one or more programs are executed by the one or more processors, the following steps are further implemented:
inputting the first regularization feature into a self-attention module for processing, wherein the self-attention module comprises multiple cascaded self-attention units, an input feature of a first self-attention unit is the first regularization feature, an input feature of an i^{th} self-attention unit is an output feature of an (i−1)^{th} self-attention unit, various self-attention units are used for outputting multiple attention features with different feature scales, and i is a positive integer greater than 1;
concatenating the multiple attention features with different feature scales in a spatial dimension to obtain a concatenated feature; and
performing linearization, batch normalization, and nonlinear activation on the concatenated feature to obtain the encoded feature.

11. The apparatus for generating electric power dispatching task according to claim 8, wherein, when the one or more programs are executed by the one or more processors, the following steps are further implemented:
determining, for each electric power device, a neighborhood device with the electric power device as the topological center;
filtering, from the operating data, operating data corresponding to the neighborhood device as neighborhood operating data;
performing embedding processing on the neighborhood operating data to obtain a second embedding feature represented by a vector of the neighborhood operating data;
performing linearization, batch normalization, and nonlinear activation on the second embedding feature to obtain a second regularization feature; and
performing convolution processing on the second regularization feature to obtain the local feature of the neighborhood with the electric power device as the topological center.

12. The apparatus for generating electric power dispatching task according to claim 8, wherein, when the one or more programs are executed by the one or more processors, the following steps are further implemented:
performing linearization processing on the fused feature to obtain a linearized feature; and
mapping the linearized feature to an instruction library of the electric power dispatching task to generate the electric power dispatching task.

13. The apparatus for generating electric power dispatching task according to claim 8, wherein, when the one or more programs are executed by the one or more processors, after generating the electric power dispatching task based on the fused feature, the following steps are further implemented:
performing verification on a dispatching operation of each device in the generated electric power dispatching task based on a pre-built rule engine.

14. The apparatus for generating electric power dispatching task according to claim 8, wherein, when the one or more programs are executed by the one or more processors, after generating the electric power dispatching task based on the fused feature, the following steps are further implemented:
collecting feedback data fed back by each electric power device after executing the electric power dispatching task; and
optimizing a model parameter of a model for generating electric power dispatching task by using the feedback data as training data.

15. A non-transitory computer-readable storage medium having a computer program stored thereon, wherein, when executed by a processor, implements the following steps:
obtaining current operating data of a target power grid, wherein the operating data comprises an operating parameter of each electric power device in the target power grid, and the operating parameter comprises a current, a voltage, a power, and an operating status;
extracting a global operating feature representing global operating information of the target power grid from the operating data;
extracting, for each electric power device from the operating data, a local feature of a neighborhood with the electric power device as a topological center;
fusing the global operating feature and the local feature of each electric power device to obtain a fused feature; and
generating an electric power dispatching task based on the fused feature, wherein the electric power dispatching task comprises a dispatching operation of each electric power device.

16. The non-transitory computer-readable storage medium according to claim 15, wherein, when executed by a processor, implements the following steps:
performing embedding processing on the operating data to obtain a first embedding feature represented by a vector of the operating data;
performing linearization, batch normalization, and nonlinear activation on the first embedding feature to obtain a first regularization feature;
performing encoding processing on the first regularization feature based on a self-attention mechanism to obtain an encoded feature; and
performing global pooling processing on the encoded feature to obtain the global operating feature representing global operating information of the target power grid.

17. The non-transitory computer-readable storage medium according to claim 16, wherein, when executed by a processor, implements the following steps:
inputting the first regularization feature into a self-attention module for processing, wherein the self-attention module comprises multiple cascaded self-attention units, an input feature of a first self-attention unit is the first regularization feature, an input feature of an i^{th} self-attention unit is an output feature of an (i−1)^{th} self-attention unit, various self-attention units are used for outputting multiple attention features with different feature scales, and i is a positive integer greater than 1;
concatenating the multiple attention features with different feature scales in a spatial dimension to obtain a concatenated feature; and
performing linearization, batch normalization, and nonlinear activation on the concatenated feature to obtain the encoded feature.

18. The non-transitory computer-readable storage medium according to claim 15, wherein, when executed by a processor, implements the following steps:
determining, for each electric power device, a neighborhood device with the electric power device as the topological center;
filtering, from the operating data, operating data corresponding to the neighborhood device as neighborhood operating data;
performing embedding processing on the neighborhood operating data to obtain a second embedding feature represented by a vector of the neighborhood operating data;
performing linearization, batch normalization, and nonlinear activation on the second embedding feature to obtain a second regularization feature; and
performing convolution processing on the second regularization feature to obtain the local feature of the neighborhood with the electric power device as the topological center.

19. The non-transitory computer-readable storage medium according to claim 15, wherein, when executed by a processor, implements the following steps:
performing linearization processing on the fused feature to obtain a linearized feature; and
mapping the linearized feature to an instruction library of the electric power dispatching task to generate the electric power dispatching task.

20. The non-transitory computer-readable storage medium according to claim 15, wherein, when executed by a processor, after generating the electric power dispatching task based on the fused feature, implements the following steps:
performing verification on a dispatching operation of each device in the generated electric power dispatching task based on a pre-built rule engine.
